(19) United States
(12) Patent Application Publication
(10) Pub. No.: US 2008/0129864 A1
(43) Pub. Date: Jun. 5, 2008

(54) Distribution of Closed Captioning From a Server to a Client Over a Home Network

(75) Inventors: Christopher J. Stone, Newtown, PA (US); Albert Fitzgerald Elcock, Havertown, PA (US); Patrick J. Leary, Horsham, PA (US); Jeffrey M. Newdeck, Plymouth Meeting, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/565,961

(22) Filed: Dec. 1, 2006

(51) Int. Cl. H04N 7/00

(52) U.S. Cl. 348/468; 348/E07.091

(57) ABSTRACT

A multimedia server distributes closed captioning over a network to a client device running a media player that does not support standardized closed captioning. The multimedia server receives a media stream including closed captioning that is encoded according to a closed captioning standard such as Consumer Electronics Association CEA-608-B or CEA 708-B, Advanced Television Systems Committee ATSC A/53 or the Society of Cable Telecommunications Engineers SCTE 20 and/or SCTE 21. The multimedia server transcodes the closed captioning into a format that is usable by the media player and transmits the transcoded closed captioning to the client device over the network so that the media player can render the closed captioning synchronously with programming content included in the media stream.

### BACKGROUND

Home networks provide users with an ability to share files, peripheral equipment such as printers and scanners, and often a high speed Internet connection. As home networking capabilities continue to grow and evolve, digital multimedia content including music, video, pictures, games and other data is increasingly accessed and shared among a larger variety of electronic devices in the home. For example, advanced programming content such as high-definition television (“HDTV”), pay-per-view entertainment (“PPV”) and video-on-demand (“VOD”) enters the home from a broadcast source such as a cable or satellite network source and is distributed over the home network where it is stored or consumed. Consumers are thus developing expectations that they will have more control over multimedia content, both to watch and use content when they want, as well as to move content to different types of displays in various rooms in the home.

Home networks often include set top boxes (“STBs”) which enable the multimedia content to be selected and played on a television or home entertainment system that is connected to the STB. In addition, as personal computers (“PCs”) have gained bigger displays and more capable audio playback capabilities, users are also relying on PCs more frequently to play multimedia content. Some PCs incorporate television tuners that allow television programming to be selected and played. However, PCs more frequently host a media player that is capable of rendering digital content. In addition to PCs, media players are commonly installed on other multimedia and portable electronic devices such as personal digital assistants (“PDAs”), mobile phones, game consoles, and multimedia players that can play video and music.

Most of the popular media players are not currently capable of displaying closed captioning that is encoded into video content according to broadcast television standards. Closed captioning is an assistive technology designed to provide access to multimedia content for persons with hearing disabilities by displaying the audio portion of the content as text on a display screen. While digital multimedia content delivery from television sources and the Internet continues to converge in many areas, a single method for delivering closed captioning to users across all multimedia platforms and devices has not emerged. As a result, closed captioning is not always available to users when watching video on PCs and other electronic multimedia devices.

### DESCRIPTION OF THE DRAWINGS

FIG. 1 is a block diagram of an illustrative home network including a multimedia server and a plurality of client devices;

FIG. 2 is a block diagram showing the control signal paths of an illustrative multimedia server;

FIG. 3 is a block diagram showing the signal flow through the transcoder module in a multimedia server;

FIG. 4 is a block diagram showing the signal flow through the closed captioning module in a multimedia server;

FIG. 5 is a block diagram of an illustrative closed captioning module;

FIG. 6 is a block diagram of a first illustrative arrangement for a client device;

FIG. 7 shows a first illustrative set of files served by a multimedia server;

FIG. 8 shows an illustrative SAMI (Synchronized Accessible Media Interchange) closed captioning file;

FIG. 9 shows an illustrative ASX (ASF Streaming Redirector) file;

FIG. 10 is an illustrative screen shot of a media player running on a client device displaying a media stream and synchronous closed captioning;

FIG. 11 shows a second illustrative set of files served by a multimedia server;

FIG. 12 shows an illustrative RealText closed captioning file;

FIG. 13 shows an illustrative SMIL (Synchronized Multimedia Integration Language) metafile;

FIG. 14 shows a third illustrative set of files served by a multimedia server;

FIG. 15 shows an illustrative plaintext file that includes closed captioning data;

FIG. 16 shows another illustrative SMIL metafile;

FIG. 17 is a block diagram of a second illustrative arrangement for a client device;

FIG. 18 shows a fourth illustrative set of files served by a multimedia server;

FIG. 19 is a block diagram of a third illustrative arrangement for a client device;

FIG. 20 is a pictorial view of an illustrative multimedia server and a plurality of client devices; and

FIG. 21 is a flowchart of an illustrative method for distributing closed captioning over a network.

### DETAILED DESCRIPTION

Disclosed is a multimedia server and related methods for distributing closed captioning over a network to one or more client devices each running a media player that does not support standardized closed captioning. The client devices typically include PCs, multimedia players, and portable electronic devices that are coupled to a home network. The multimedia server receives a media stream including closed captioning that is encoded according to a closed captioning standard such as Consumer Electronics Association CEA-608-B, CEA-708-B, Advanced Television Systems Committee ATSC A/53 or the Society of Cable Telecommunications Engineers SCTE 20 and/or SCTE 21. The multimedia server transcodes the closed captioning into a format that is usable by the media player and transmits the transcoded closed captioning to the client device over the network so that the media player can render the closed captioning synchronously with programming content included in the media stream. Advantageously, the multimedia server enables a user to see closed captioning displayed on the client device that would otherwise be lost.

Closed captioning has historically been a way for deaf and hard-of—hearing/hearing-impaired people to read a transcript of the audio portion of a video program, film, movie or other presentation. Others benefiting from closed captioning include people learning English as an additional language and people first learning how to read. Many studies have shown that using captioned video presentations enhances retention and comprehension levels in language and literacy education.

As the video plays, words and sound effects are expressed as text that can be turned on and off at the user's discretion so long as they have a caption decoder. In the United States, since the passage of the Television Decoder Circuitry Act of 1990, manufacturers of most television receivers have been required to include closed captioning decoding capability. Beginning in July 1993, the Federal Communications Commission (“FCC”) required all analog television sets with screens 13 inches or larger sold or manufactured in the United States to contain built-in decoder circuitry to display closed captioning. Beginning Jul. 1, 2002, the FCC also required that digital television (“DTV”) receivers include closed captioning display capability. In 1996, Congress required video program distributors (cable operators, broadcasters, satellite distributors, and other multi-channel video programming distributors) to close caption their television programs. Pursuant to this requirement, the FCC in 1997 set a transition schedule requiring distributors to provide an increasing amount of captioned programming.

The term “closed” in closed captioning means that not all viewers see the captions—only those who decode and activate them. This is distinguished from open captions, where the captions are permanently burned into the video and are visible to all viewers. As used in the remainder of the description that follows, the term “captions” refers to closed captions unless specifically stated otherwise.

Closed captions are further distinguished from “subtitles.” In the U.S. and Canada, subtitles assume the viewer can hear but cannot understand the language, so they only translate dialogue and some onscreen text. Closed captions, by contrast, aim to describe all significant audio content, as well as “non-speech information,” such as the identity of speakers and their manner of speaking.

For live programs in countries that use the analog NTSC (National Television System Committee) television system, like the U.S. and Canada, spoken words comprising the television program's soundtrack are transcribed by a reporter (i.e., like a stenographer/court reporter in a courtroom using stenotype or stenomask equipment). Alternatively, in some cases the transcript is available beforehand and captions are simply displayed during the program. For prerecorded programs (such as recorded video programs on television, videotapes, and DVDs), audio is transcribed and captions are prepared, positioned, and timed in advance.

For all types of NTSC programming, captions are encoded into Line 21 of the vertical blanking interval (“VBI”)—a part of the TV picture that sits just above the visible portion and is usually unseen. “Encoded,” as used in the analog case here (and in the case of digital video below) means that the captions are inserted directly into the video stream itself and are hidden from view until extracted by an appropriate decoder or decoding process.

Closed caption information is added to Line 21 of the VBI in either or both the odd and even fields of the NTSC television signal. Particularly with the availability of Field 2, the data delivery capacity (or data bandwidth) far exceeds the requirements of simple program related captioning in a single language. Therefore, the closed captioning system allows for additional “channels” of program-related information to be included in the Line 21 data stream. In addition, multiple channels of non-program related information are possible.

The decoded captions are presented to the viewer in a variety of ways. In addition to various character formats such as upper/lower case, italic, and underline, the characters may “Pop-On” the screen, appear to “Paint-On’ from left to right, or continuously “Roll-Up” from the bottom of the screen. Captions may appear in different colors as well. The way in which captions are presented, as well their channel assignment, is determined by a set of overhead control codes which are transmitted along with the alphanumeric characters which form the actual caption in the VBI.

Sometimes music or sound effects are also described using words or symbols within the caption. The Consumer Electronics Association (“CEA”) defines the standard for NTSC captioning in CEA-608-B. Virtually all television equipment including videocassette players and/or recorders (collectively, “VCRs”), DVD players, DVRs (digital video recorders) and STBs with NTSC output can output captions on line 21 of the VBI in accordance with CEA-608-B.

For ATSC (Advanced Television Systems Committee) programming (i.e., digital- or high-definition television, DTV and HDTV, respectively, collectively referred to here as “DTV”), three data components are encoded in the video stream: two are backward compatible Line 21 captions, and the third is a set of up to 63 additional caption streams encoded in accordance with another standard—CEA-708-B. DTV closed captioning is covered by the ATSC A/53 standard for the carriage of line 21 VBI data which was extended under the SCTE 21 standard for CEA-608-B-compliant closed captioning to be supported by one or more VBI lines other than line 21. All DTV signals are compliant with the MPEG-2 protocol (Moving Pictures Expert Group). This protocol is commonly used in digital cable and satellite services, streaming Internet video and DVD (digital versatile disc) and defines the syntax and semantics for the movement of compressed digital content across a network.

Closed captioning in DTV is based around a caption window (i.e., like a “window” familiar to a computer user where the caption window overlays the video and closed captioning text is arranged within it). DTV closed captioning and related data is carried in three separate portions of the MPEG-2 data stream. They are the picture user data bits, the Program Mapping Table (PMT), and the Event Information Table (EIT). The captioning text itself and window commands are carried in the MPEG-2 Transport Channel in the picture user data bits. A captioning service directory (which shows which caption services are available) is carried in the PMT and optionally for cable, in the EIT. To ensure compatibility between analog and digital closed captioning (CEA-608-B and CEA-708-B, respectively), the MPEG-2 transport channel is designed to carry both formats.

The backwards compatible line 21 captions are important because some users want to receive DTV signals but display them on their NTSC television sets. Thus, DTV signals can deliver Line 21 caption data in a CEA-708-B format. In other words, the data does not look like Line 21 data, but once recovered by the user's decoder, it can be converted to Line 21 caption data and inserted into Line 21 of the NTSC video signal that is sent to an analog television. Thus, line 21 captions transmitted via DTV in the CEA-708-B format come out looking identical to the same captions transmitted via NTSC in the CEA-608-B format (in a CEA-608 format along with CEA-708 formatted data). This data has all the same features and limitations of 608 data, including the speed at which it is delivered to the user's equipment.

While U.S. law and FCC regulations cover closed captioning support in broadcast television, there is no equivalent scheme governing video delivered over the Internet. Accordingly, most of the popular media players such as Microsoft Media Player, Real Networks RealPlayer, and Apple QuickTime, iTunes, and iTunes Video—which were developed primarily for streaming video over Internet applications—have no native support for closed captioning that is encoded according to the standards for broadcast television, including CEA-608-B, CEA-708-B, ATSC A/53 and SCTE 20 and/or SCTE 21 (wherein a “native” format is one that the media player normally reads). That is, these media players are incapable of extracting and using the standardized closed captioning in their original form.

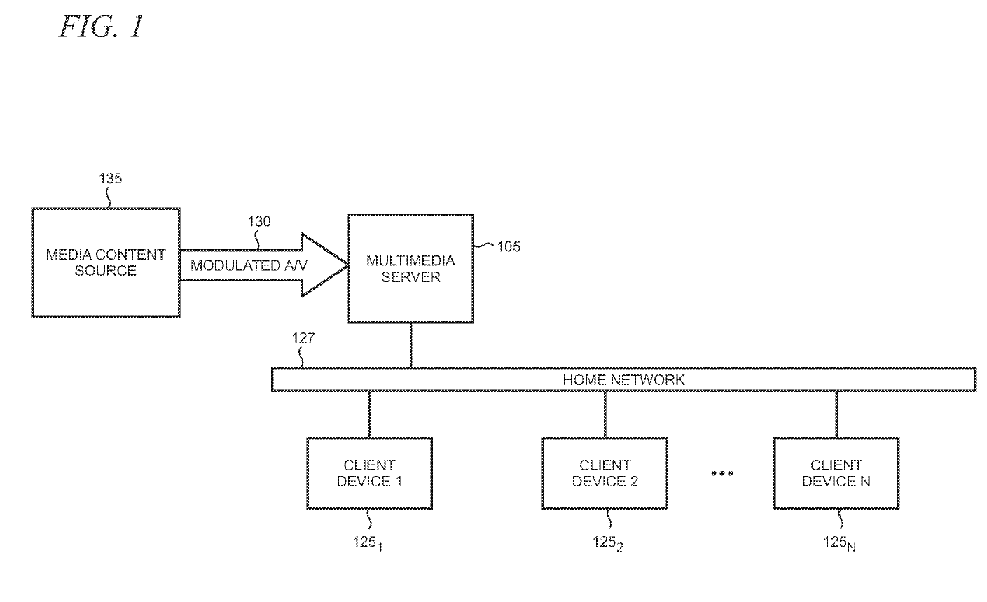

Turning now to FIG. 1, a block diagram of an illustrative network arrangement is shown including a multimedia server 105 that is coupled to a plurality of client devices 125₁ to 125_{N}. The multimedia server 105 is in operative communication with the client devices 125 over a network, which in this illustrative example is a home network 127. Home network 127 is typically implemented using an Ethernet type networking (e.g., wired or wireless Ethernet) using Internet Protocol (“IP”) addressing. Home network 127 is often arranged to include wireless capability using wireless access points (not shown in FIG. 1) that communicate with one or more client devices in accordance with IEEE 802.11x (Institute of Electrical and Electronic Engineers where “x” is used to designate any of the variety of protocols including 802.11(a), 802.11(b), 802.11(g) and 802.11(n)). Various networking types, protocols, and arrangements are alternatively used to implement home network 127 depending upon the requirements of a specific application of closed captioning distribution from a server to a client over a home network. The arrangements include, for example, a coaxial cable network, MoCA (Multimedia over Coax Alliance) network, HomePlug network, HPNA (Home Phoneline Networking Alliance) network, powerline network, or telephone network.

Client devices 125 are typically selected from consumer electronic devices including, for example, PCs, STBs, thin client STBs, mobile phones, music players, multimedia players, handheld game devices, laptop and notebook computers, webpads, PDAs, and the like. Client devices 125 each host a media player which is generally implemented as a software application either on a standalone basis, or built into a web browser (often as a “plug-in”) and include, for example, Microsoft Windows Media Player, Real Networks RealPlayer, and Apple QuickTime, iTunes, and iTunes Video.

Multimedia server 105 receives a modulated A/V (audio/video) signal 130 from a media content source 135. In most applications, A/V signal 130 is a digital signal carrying multiple channels of audio, video, and closed captioning data in accordance with CEA-708-B for digital television. In alternative arrangements, A/V signal 130 is an analog signal carrying multiple channels of audio, video and closed captioning in line 21 of the VBI in accordance with CEA-608-B for NTSC television.

Media content source 135 is alternatively arranged from such sources as a satellite network source, such as one used in conjunction with a direct broadcast service, a CATV (community access television) source for implementing cable television and broadband Internet access services, and a telecommunications network for implementing a digital subscriber line (“DSL”) service.

Multimedia server 105 is commonly incorporated into a STB and is optionally configured with DVR capabilities and thus includes a hard disk drive or other memory (not shown). In this case, multimedia server 105 is capable of serving multimedia content to client devices 125 substantially in real time as the modulated A/V signal 130 is received. Multimedia server 105 is also capable of recording incoming multimedia content to its DVR for distribution to the client devices at a later time. Alternatively, multimedia server 105 is arranged from devices such as personal computers, media jukeboxes, audio/visual file servers, and other devices that can receive, store, and serve multimedia content over home network 127.

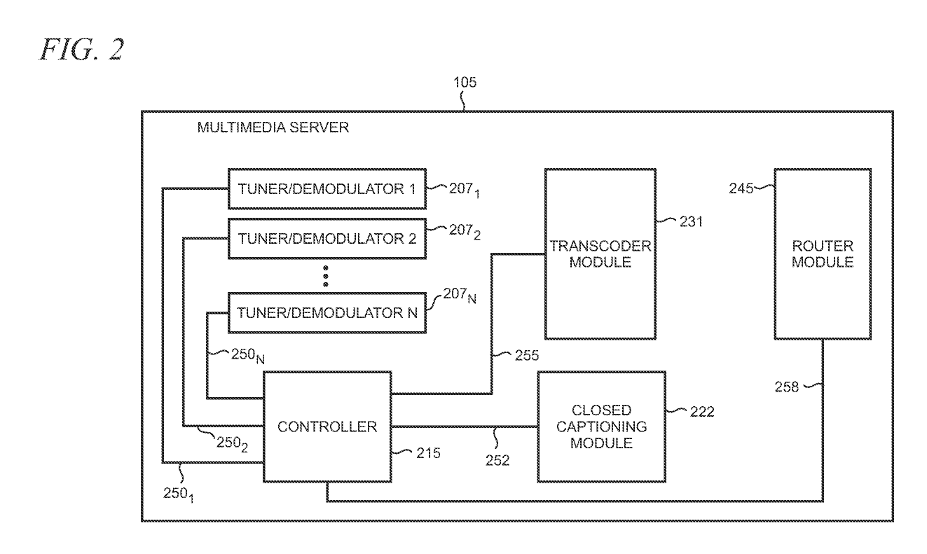

FIG. 2 is a block diagram showing the control signal paths disposed in multimedia server 105 (FIG. 1). As shown, multimedia server 105 comprises a plurality of tuner/demodulators 207₁ to 207_{N}, a controller 215, a closed captioning module 222, a transcoder module 231 and a router module 245. The controller 215 is operatively coupled to the tuner/demodulators 207 through signal paths 250₁ to 250_{N}. Controller 215 is further operatively coupled to the closed captioning module 222, transcoder module 231 and router module 245 over signal paths 252, 255 and 258, respectively. Controller 215 operates to provide central control over the features and functions enabled by the multimedia server 105 and its components therein.

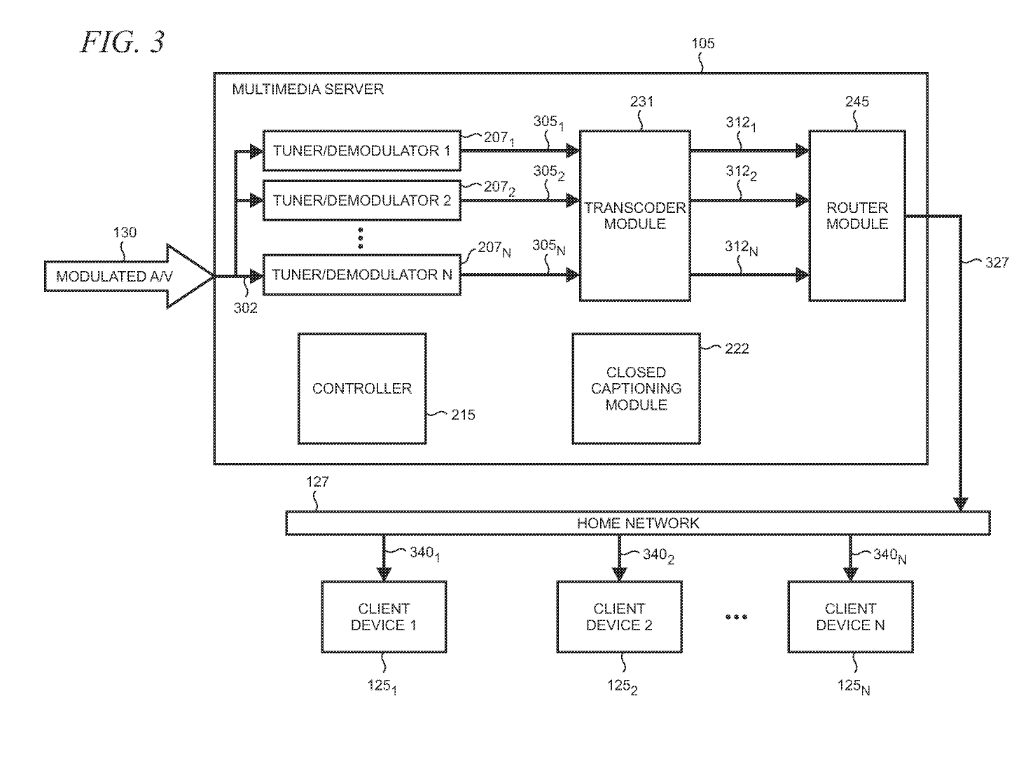

FIG. 3 is a block diagram showing the signal flow through the transcoder module 231 (FIG. 2) in multimedia server 105 (FIG. 1). The modulated A/V signal 130 is received at an input to the multimedia server 105 where it is distributed on lines 302 to each of the plurality of tuner/demodulators 207. The tuner/demodulators 207 tune to, demodulate, and extract the audio, video, and closed captioning from the A/V signal 130. The tuned and demodulated individual audio and video channels—which typically comprise television, movie, music and other entertainment programming—are transmitted from the tuner/demodulators 207 to the transcoder module 231 on respective lines 305₁ to 305_{N}. In most applications, the individual audio and video channels are encoded as MPEG-2 compliant streams which are optionally further encrypted to enable secure distribution from the media content source 135 (FIG. 1) through to the client devices 125 which consume the media content.

Transcoder module 231 transcodes the A/V channels into a format that is suitable for one or more of the client devices 125. In an illustrative example, client device 125₁ is configured to host a Windows Media Player application. Windows Media Player does not include built-in MPEG-2 support. That is, Windows Media Player is not supplied by Microsoft with an MPEG-2 decoder, but rather, includes native support for its own proprietary Windows Media Video (“WMV”) formatted video streams. Additional features such as audio and video effects and new rendering types, are commonly added to Windows Media Player (and the other popular media players) through the installation of “plug-ins” which is a computer program that is designed to work with the media player to provide the desired feature or functionality.

Transcoder module 231 receives an MPEG-2 stream, for example on line 3051, and transcodes the received stream into a WMV formatted stream that is output on line 327 from the multimedia server 105 to the home network 127. The transcoding optionally includes security encryption or imposition of other digital rights management (“DRM”) schemes that are compliant with the Windows Media Player security feature set. The WMV formatted stream is received on line 340₁ from home network 127 and stored or played by the Windows Media Player on the client device 125₁.

Transcoder module 231 outputs a plurality of transcoded AV signals on lines 312₁ to 312_{N} to router module 245. Router module 245 is utilized to route the transcoded AV signals 312 to the client devices 125. In some applications, such routing is performed in response to a request to the multimedia server 105 by a client device 125 to receive multimedia content. For example, a user of a client device 125 such as a PC wishing to view programming content typically interacts with a menu application running on client device 125. The menu application enables a user to browse and select programming content that is available to be served by multimedia server 105 to thereby initiate a multimedia viewing event on the client device 125. Typically, the menu is implemented with common electronic programming guide (“EPG”) features using a standalone software application. Alternatively, the menu is implemented using HTML (Hypertext Markup Language) code readable by a web browsing application.

Router module 245, in an illustrative example, encapsulates the transcoded A/V signals 312 in an IP layer in an output stream 327 using an IP datagram addressing methodology in which the destination IP address is the IP address of the requesting client device 125. Alternatively, router module 245 uses an IEEE-1394 compliant delivery protocol where transmission of the transcoded A/V signals 312 to the client devices 125 is performed isochronously. In this case, either IEEE EUI-64 (extended unique identifier) 64 bit addressing or IEEE 802.11 48 bit addressing is usable depending upon the requirements of a specific application. The transcoded A/V signals 312 are delivered over network 127 to the client devices 125 on lines 340, as shown.

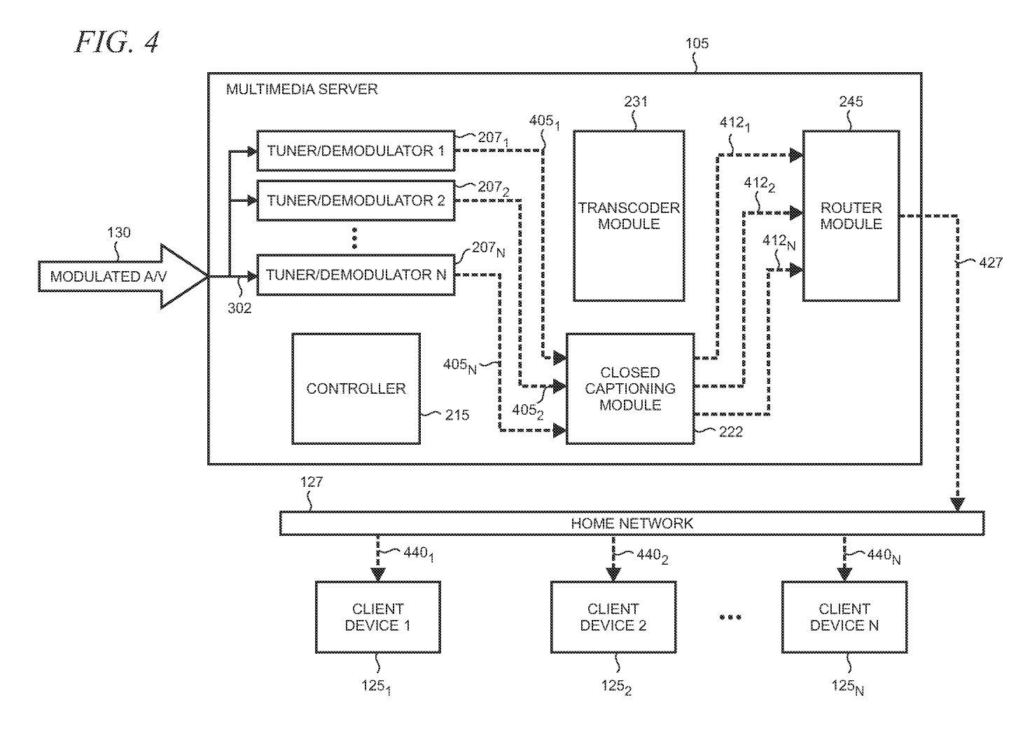

FIG. 4 is a block diagram showing the signal flow through the closed captioning module 222 in multimedia server 105. The modulated A/V signal 130 is received at an input to the multimedia server 105 where it is distributed on lines 302 to each of the plurality of tuner/demodulators 207. The tuner/demodulators 207 extract the closed captioning that is encoded in the associated programming content in the A/V signal 130. The programming content is extracted from A/V signal 130 as described above in the text accompanying FIG. 3.

As noted above, the closed captioning is encoded in A/V signal 130 using standard closed captioning encoding techniques and in particular, CEA-708-B (and/or CEA-608-B). The extracted closed captioning data is output from the tuner/demodulators 207 to the closed captioning module 222 on respective lines 405₁ to 405_{N}.

Closed captioning module 222 transcodes the extracted closed captioning data into a format that is suitable for one or more of the client devices 125. For example, as with the illustrative example described above in the text accompanying FIG. 3, client device 125₁ is configured to host a Windows Media Player application. As described above, Windows Media Player does not support standardized CEA-708-B captioning. To resolve this inability, closed captioning module 222 receives the extracted closed captioning data associated with programming content being delivered to client device 1251, for example on line 4051, and transcodes the received data into a format that is usable by Windows Media Player. The transcoded closed captioning data is transmitted on line 427 from the multimedia server 105 to the home network 127. The transcoding optionally includes security encryption or imposition of other DRM schemes that are compliant with the Windows Media Player security feature set. The transcoded closed captioning data is received on line 440₁ from home network 127 and stored or played by the Windows Media Player on the client device 125₁.

Closed captioning module 222 outputs a plurality of transcoded closed captioning data signals on lines 412₁ to 412_{N} to router module 245. In a similar manner for routing the A/V signals 312 (FIG. 3), router module 245 is utilized to route the transcoded closed captioning data signals 412 to a particular one of the client devices 125. However, in most applications, the delivery of the transcoded closed captioning data signals 412 is performed asynchronously. Such asynchronous delivery is implemented using either IP addressing or the AV/C (Audio/Video Control) command set covered by IEEE 1394. The transcoded closed captioning data signals 412 are delivered over network 127 to the client devices 125 on lines 440, as shown.

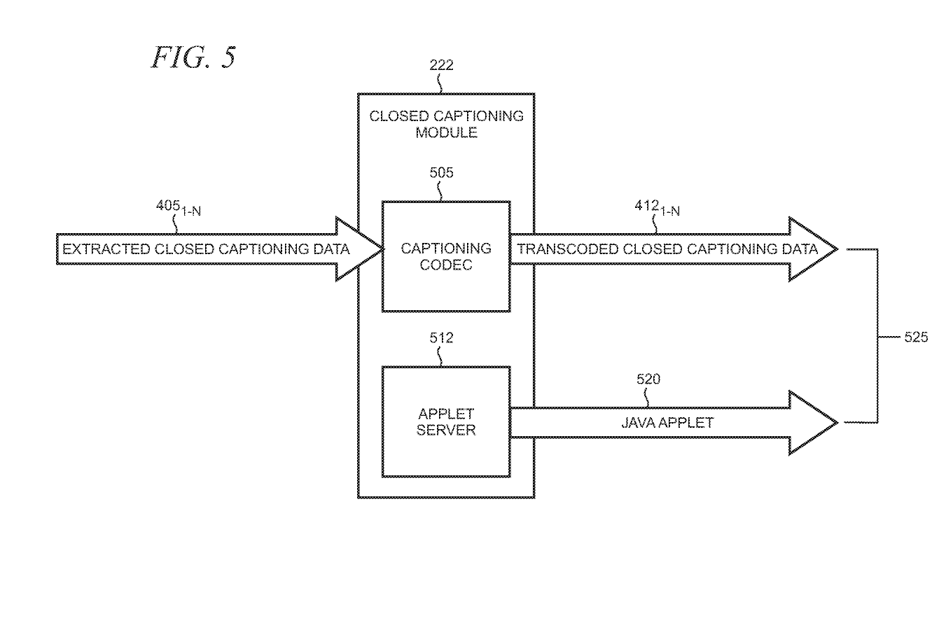

FIG. 5 is a block diagram showing details of closed captioning module 222 (FIG. 2). Closed captioning module 222 includes a closed captioning codec (coder/decoder) 505 for receiving the extracted closed captioning data 405 (FIG. 4) and transcoding the received data into the transcoded closed captioning data 412 (FIG. 4). Also disposed in closed captioning module 222 is an optional applet server 512 for providing, in an illustrative example, a Java applet 520 to the client devices 125 (FIG. 1) over network 127 (FIG. 1). A Java applet is a program written in the Java programming language that is typically embeddable in an HTML page that is rendered by a web browser. Used here, the Java applet is one of several alternatives, as described below, for enabling a client device 125 to render the transcoded closed captioning data 412. The transcoded closed captioning and optional Java applet are collectively indicated by reference numeral 525 in FIG. 5.

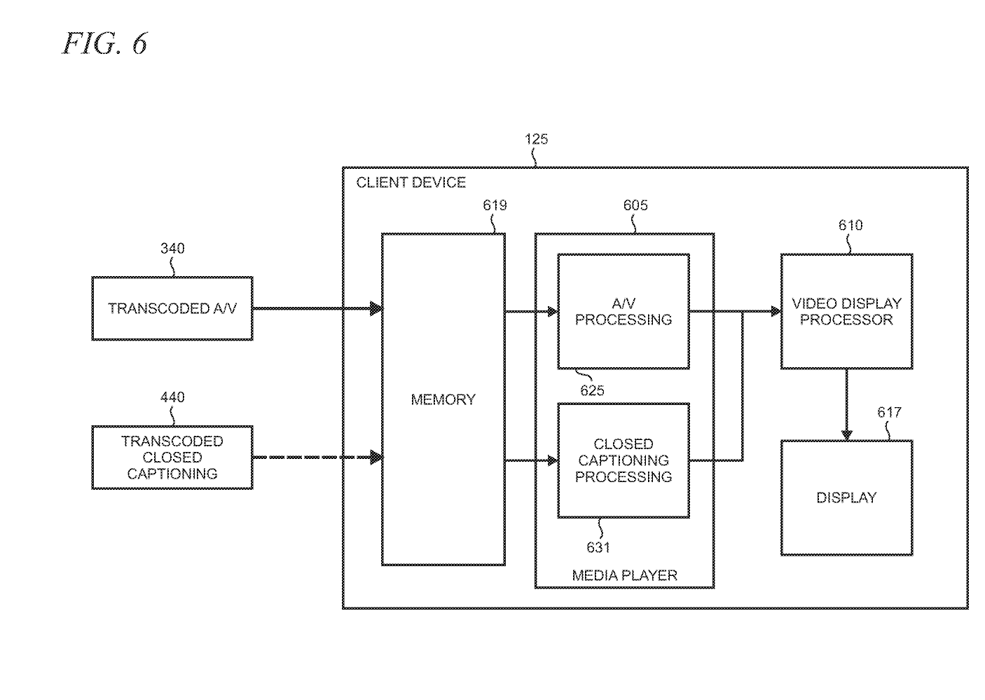

FIG. 6 is a block diagram of a first illustrative arrangement for a client device 125 (FIG. 1). Client device 125 hosts a media player application 605 for playing multimedia content including video, audio (e.g., music), and data (e.g., pictures and photographs). The media player 605 is functionally coupled, in typical consumer electronic devices, to a video display processor 610 which renders video and visual data content on a display 617. The display may be incorporated into the client device, such as in the cases of mobile phones, PDAs, handheld games, laptop computers, and music players, or be arranged as an external device for STB or PC applications.

A transcoded A/V signal 340 is received by the client device 125 which typically contains programming content such as a television show or movie. As noted above, the transcoded A/V signal is formatted to be usable by the media player hosted by the client device 125. For example, if media player 605 is arranged as a Windows Media Player, then the transcoded A/V signal 340 is formatted as a WMV compliant signal (i.e., a native format for Windows Media Player) which is either streamed or served from multimedia server 105 (FIG. 1).

The transcoded A/V signal 340 is buffered or stored in memory 619. The transcoded closed captioning 440 that is associated with the television programming in the transcoded A/V signal 340 is also buffered or stored in memory 619. The transcoded A/V signal 340 and closed captioning 440 is read from memory 619 by media player 605. Media player 605 supports several processes including A/V processing 625 and closed caption processing 631. A/V processing 625 includes decoding and decrypting, as appropriate, the transcoded A/V signal 340 and outputting a corresponding video output signal to the video display processor 610 for presentation on the display 617. Closed captioning processing 631 includes parsing the transcoded closed captioning 440, synchronizing the closed captioning with the A/V signal 340 and then outputting the closed captions to the video display processor 610 so that they are rendered on the display 617.

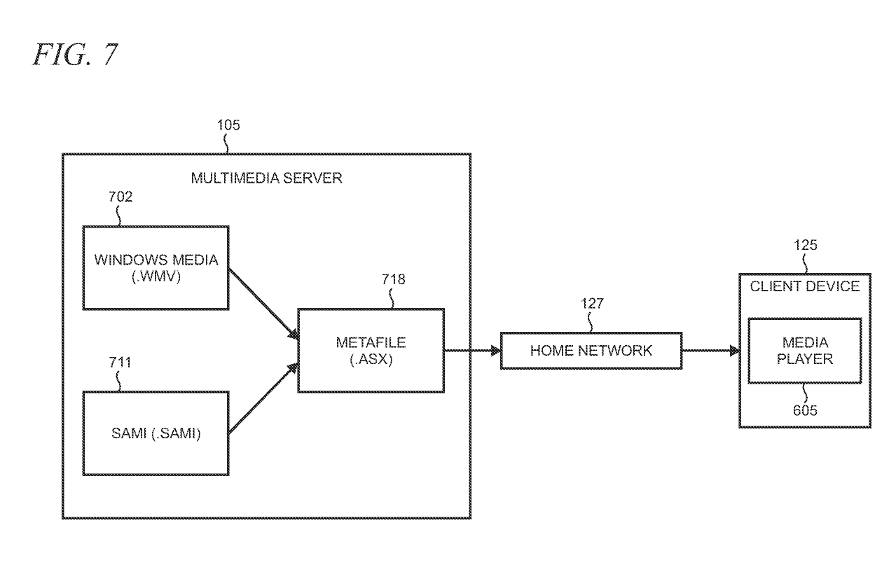

FIG. 7 shows a first illustrative set of files served by multimedia server 105. The files shown in FIG. 7 are transmitted over the home network 127 (FIG. 1) and used by the client device 125 as arranged in FIG. 6 to render video content and associated closed captioning. Client device 125 hosts a media player 605, which in this illustrative example is arranged as a Windows Media Player.

Transcoder 231 (FIG. 2) creates a Windows Media Video, or WMV file 702, during the A/V transcoding process. An alternative, older native file format for Windows Media Player is AVI (Audio Video Interleave) having an .avi file extension. The closed captioning module 222 (FIG. 2) creates a SAMI (Synchronized Accessible Media Interchange) file 711 and ASX (ASF Streaming Redirector) metafile 718 during the closed captioning transcoding process.

SAMI is a file format developed by Microsoft that is designed to deliver synchronized text such as captions, subtitles, or audio descriptions with digital media content. The Windows Media Player includes native support for SAMI and captioning delivered in SAMI may be rendered directly by the player without the necessity for any additional plug-ins or software.

SAMI files are plaintext files that have a .smi or .sami file name extension. They contain the text strings used for synchronized closed captions, subtitles, and audio descriptions. They also specify the timing parameters used by the Windows Media Player to synchronize closed caption text with audio portion of the programming content. When a media file reaches a time designated in the SAMI file, the captioning text changes accordingly in the closed caption display area in the media player.

SAMI and HTML share common elements, such as the <HEAD> and <BODY> tags. As in HTML, tags used in SAMI files must always be used in pairs. For example, a BODY element begins with a <BODY> tag and must always end with a </BODY> tag. A basic SAMI file requires three fundamental tags: <SAMI>, <HEAD>, and <BODY>. The <SAMI> tag identifies the document as a SAMI document so other applications can recognize its file format. Between the <HEAD> and </HEAD> tags, basic guidelines and other format information for the SAMI file, such as the document title, general information, and style properties for closed captions are defined. Like HTML, content declared within the HEAD element does not display as output. Elements and attributes defined between the <BODY> and </BODY> tags display content seen by the user. In SAMI, the BODY element contains the parameters for synchronization and the text strings used for closed captions. Defined within the HEAD element, the STYLE element provides for added functionality in SAMI. Between the <STYLE> and </STYLE> tags, several Cascading Style Sheet (“CSS”) selectors for style and layout may be defined. Style properties such as fonts, sizes, and alignments can be customized to provide a rich user experience while also promoting accessibility. For example, defining a large text font style class can improve the readability for users who have difficulty reading small text.

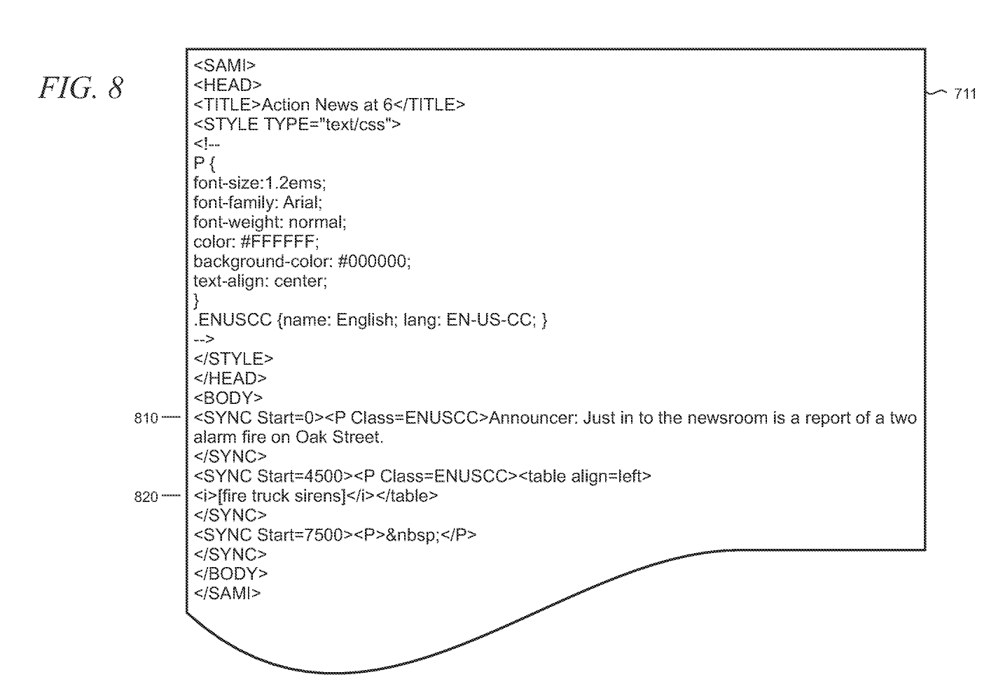

FIG. 8 shows the content of SAMI file 711. As indicated by reference numeral 810, a caption is timed to start at time=0. As indicated by reference numeral 820, at time=4500 milliseconds, a descriptive sound caption is rendered.

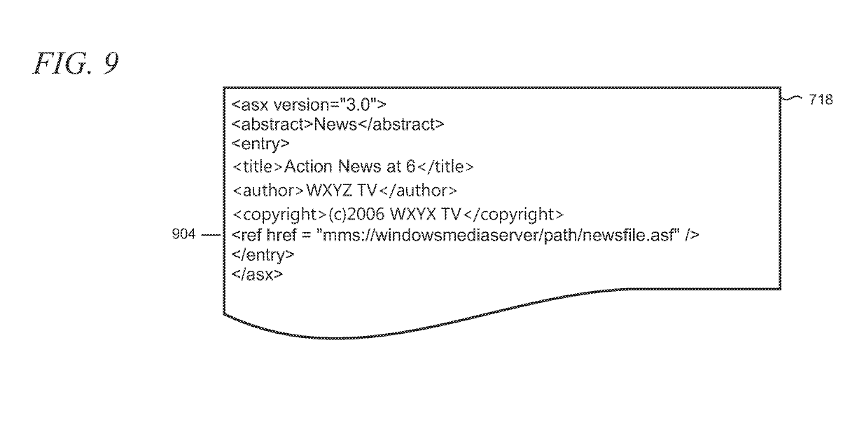

FIG. 9 shows the content of ASX metafile 718 (FIG. 7) which is a plaintext file based on the extensible markup language (“XML”) that is used to describe the data in the WMV file 702 (FIG. 7) and SAMI file 711 (FIG. 7). In addition to metadata such as title, author, and copyright information, the ASX metafile 718 includes a uniform resource locator (“URL”) to identify the WMV file 702 and SAMI file 711 to be played by the Windows Media Player 605 (FIG. 6).

Reference numeral 904 indicates that the “ref” element has an “href” attribute value that refers to the location of the media file. In this illustrative example, the location is a Windows media server disposed in multimedia server 105 (FIG. 1). The “MMS” (Microsoft Media Server) server control protocol designation indicates that the media file is streamed from multimedia server 105. Other usable server control protocols include HTTP (Hyper Text Transfer Protocol) and RTSP (Real Time Streaming Protocol), for example. The RTSP and MMS protocols support client control actions such as stopping, pausing, rewinding, and fast-forwarding indexed Windows Media files, and are commonly used for streaming on-demand multimedia files. While the HTTP protocol can support streaming in a more limited way (for example, HTTP does not support automatic detection of connection speeds), it is more typically used to serve complete files to the client devices 125. Thus, multimedia server 105 is alternatively arranged to download all the files shown in FIG. 7 in complete form to the client devices 125, stream the files, or perform some combination of downloading and streaming depending on specific requirements of an application of closed captioning distribution.

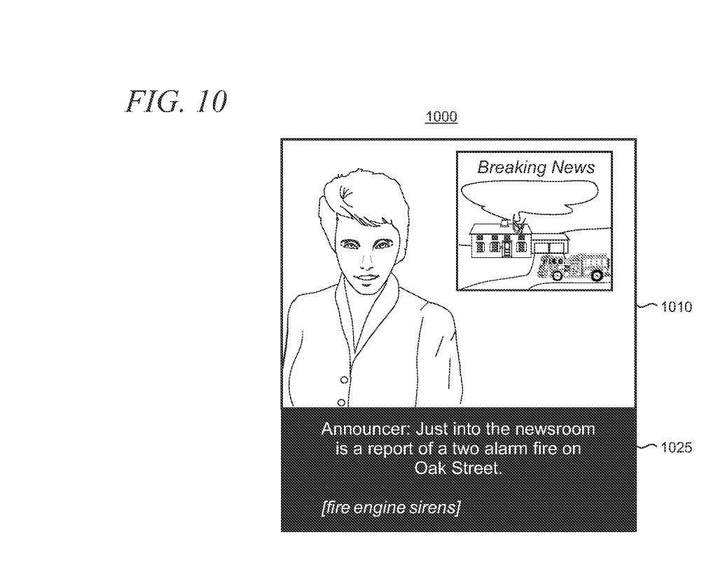

FIG. 10 is an illustrative screen shot 1000 of a media player running on a client device displaying a media stream and rendering synchronous closed captioning. The screen shot 1000 includes a video image display area 1010 and a closed captioning display area 1025. The closed captioning display area 1025 is used to render the closed captioning contained in the SAMI file shown in FIG. 8 and described in the accompanying text.

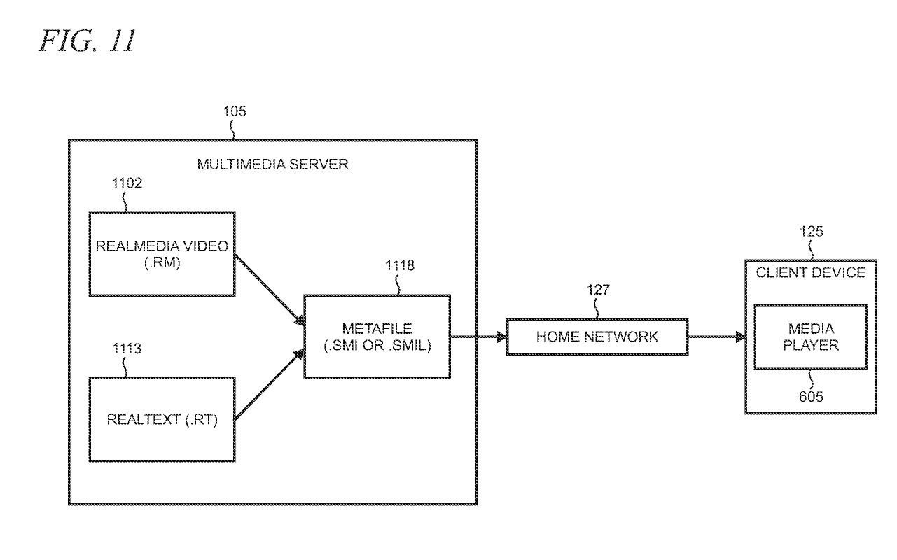

FIG. 11 shows a second illustrative set of files served by multimedia server 105 (FIG. 1). The files shown in FIG. 11 are transmitted over the home network 127 (FIG. 1) and used by the client device 125 as arranged in FIG. 6 to render video content and associated closed captioning. Client device 125 hosts a media player 605, which in this illustrative example is arranged as a RealMedia Player.

The transcoder 231 (FIG. 2) creates a RealMedia Video file 1102 during the A/V transcoding process. The RealMedia Video file typically includes a .rm or .ram file extension. The closed captioning module 222 (FIG. 2) creates a RealText file 1113 (having an .rt file extension) and SMIL metafile 1118 (having a .smi or .smil file extension) during the closed captioning transcoding process.

RealText is a file format developed by RealMedia that is designed to deliver synchronized text such as captions, subtitles, or audio descriptions with digital media content. The RealMedia Player includes native support for RealText and captioning delivered in RealText may be rendered directly by the player without the necessity for any additional plug-ins or software.

RealText files are plaintext files using the XML programming language that have a similar structure to HTML and may use HTML tags. Like the SAMI file shown in FIG. 8 and described in the accompanying text, RealText contains the text strings used for synchronized closed captions, subtitles, and audio descriptions. They also specify the timing parameters used by the RealMedia Player to synchronize closed caption text with the audio portion of the programming content. When a media file reaches a time designated in the RealText file, the captioning text changes accordingly in the closed caption display area in the media player.

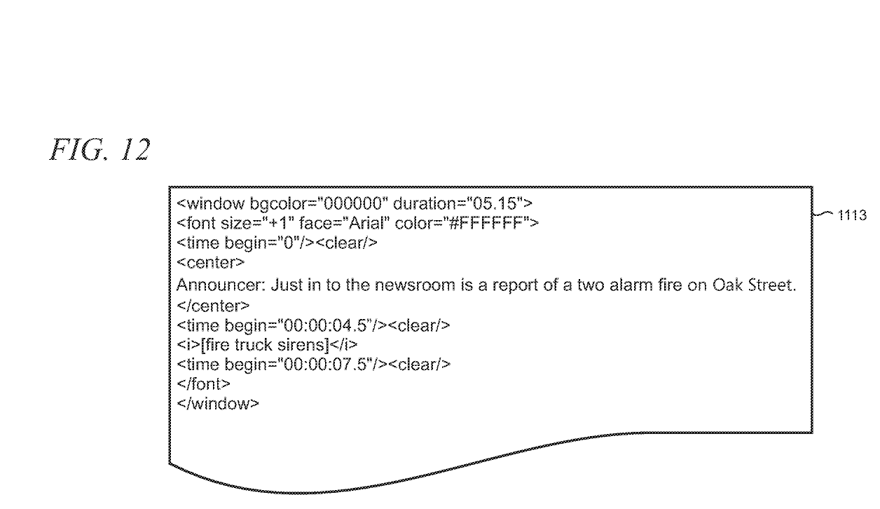

FIG. 12 shows the content of RealText file 1113. Realtext file 1113 includes the same captioning content and timing as the closed captioning file 711 shown in FIG. 8.

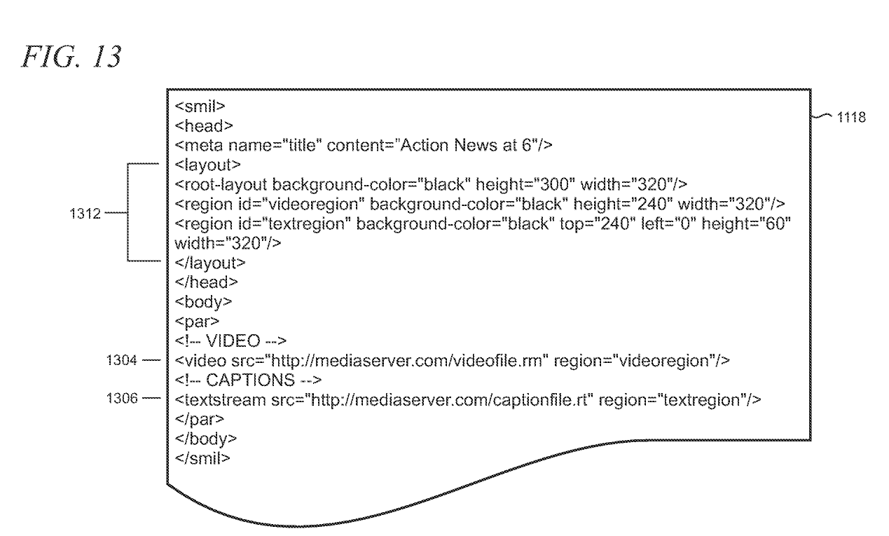

FIG. 13 shows the content of the SMIL metafile 1118 (FIG. 11) which is used to describe the data in the RealMedia Video file 1102 (FIG. 11) and RealText file 1113 (FIG. 11). In addition to metadata such as title, the SMIL metafile 1118 includes a uniform resource locator (“URL”) to identify the RealMedia Video file 1102 and RealText closed captioning file 1113 to be played by the RealMedia Player 605 (FIG. 6).

Reference numerals 1304 and 1306, respectively, show the “video src” value which indicates the location of the RealMedia Video file 1102 and the “text stream src” value which indicates the location of the RealText file 1113. In this illustrative example, the location is a media server disposed in multimedia server 105 (FIG. 1). Here, the HTTP server control protocol is used. As noted above, other usable server control protocols include MMS and RTSP.

Reference numeral 1312 in FIG. 13 indicates the layout tags in the SMIL metafile 1118 which contain layout information used by the RealMedia Player 605. The size and color of the regions used to display the RealMedia Video content and render the closed captioning in the RealText file are embedded within the layout tags as shown. The video region is sized as 320 pixels wide by 240 pixels tall. The closed captioning region (called the “text region” in the SMIL metafile 1118) is 320 pixels wide by 60 pixels tall and is positioned, in this illustrative example, below the video region.

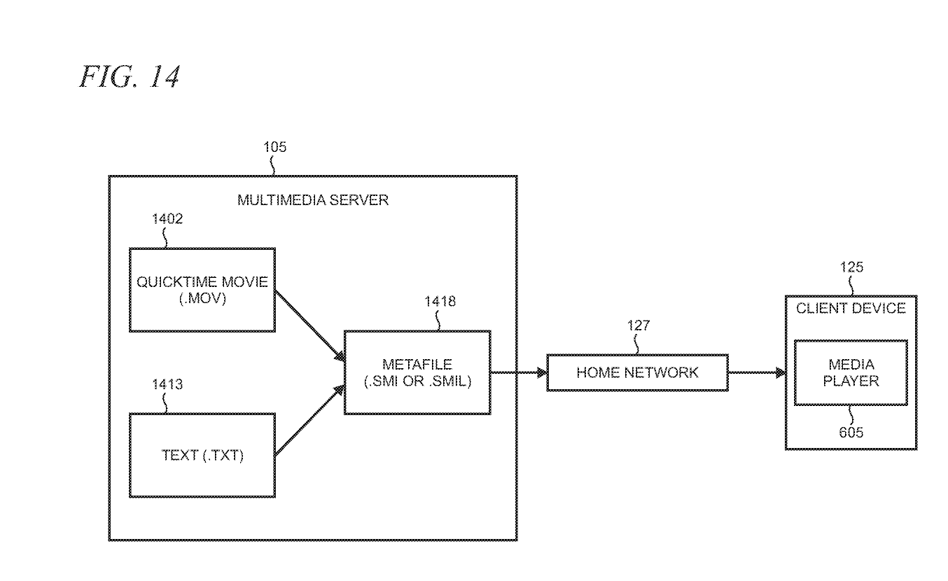

FIG. 14 shows a third illustrative set of files served by multimedia server 105 (FIG. 1). The files shown in FIG. 14 are transmitted over the home network 127 (FIG. 1) and used by the client device 125 as arranged in FIG. 6 to render video content and associated closed captioning. Client device 125 hosts a media player 605, which in this illustrative example is arranged as an Apple QuickTime player. Alternatively, media player 605 is arranged as an Apple iTunes Video player with native support for the MPEG-4 video standard.

The transcoder 231 (FIG. 2) creates an Apple QuickTime Movie file 1402 during the A/V transcoding process. The Apple QuickTime file typically includes an .mov file extension. Alternatively, transcoder 231 creates an MPEG-4 video file (having an .mp4 file extension). The closed captioning module 222 (FIG. 2) creates a plaintext file 1413 (having a .txt file extension) and SMIL metafile 1418 (having a .smi or .smil file extension) during the closed captioning transcoding process.

The plaintext file 1413 contains information about what captions will display, when they will display, and what they will look like to thereby deliver synchronized text such as captions, subtitles, or audio descriptions with the programming content contained in the QuickTime Movie File 1402. When the plaintext file 1413 is supplied with the SMIL metafile 1418, the closed captioning included therein may be rendered directly by the Apple QuickTime player without the necessity for any additional plug-ins or software.

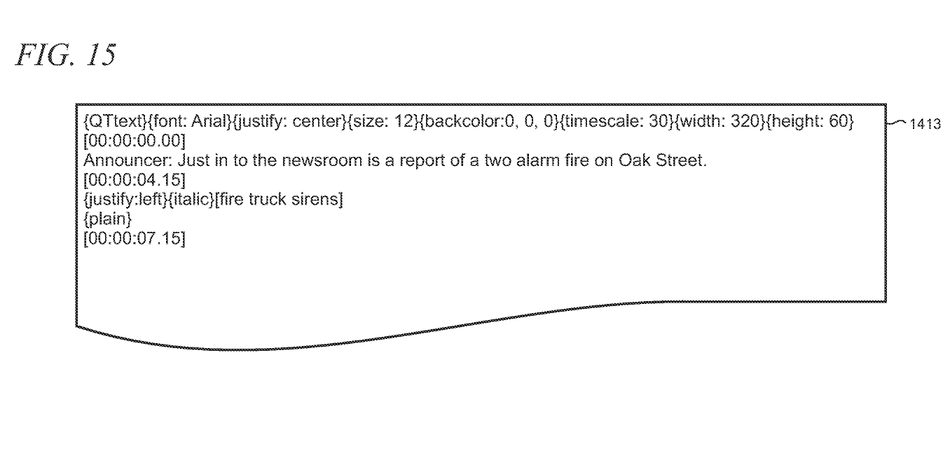

FIG. 15 shows the content of plaintext file 1413 that is renderable by the Apple QuickTime player 605 in FIG. 14. Plaintext file 1413 includes the same captioning content and timing as closed captioning file 711 shown in FIG. 8. Note that the time stamp of “04.15” in FIG. 15 means four and 15/30^{th} seconds. Plaintext file 1413 specifies a closed captioning region of 320 pixels wide by 60 pixels tall. Plaintext file 1413 further specifies closed captioning formatting such as font, size and positioning.

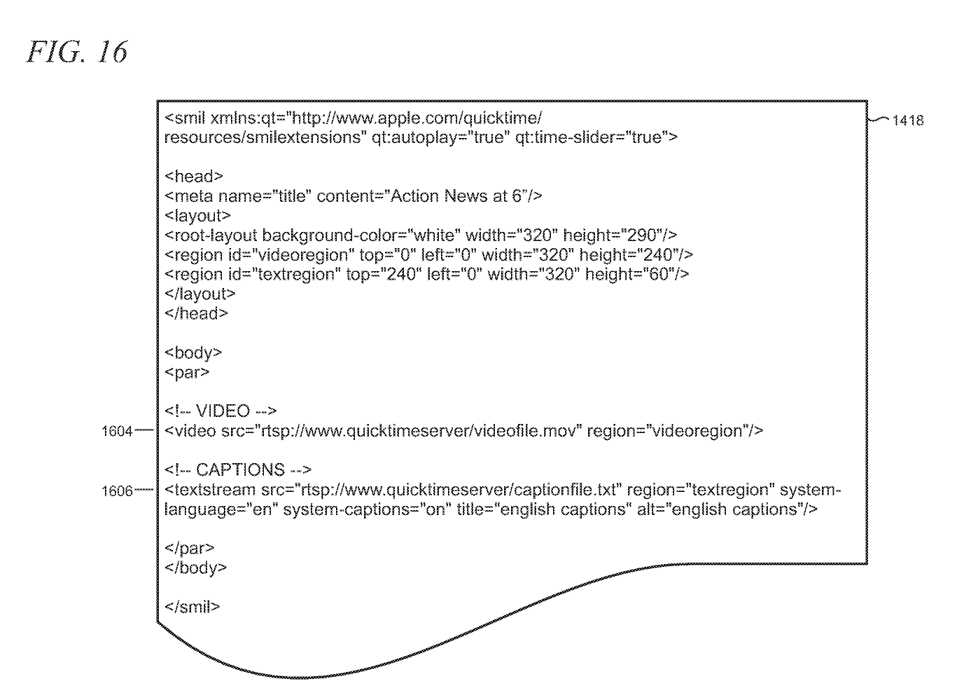

FIG. 16 shows the contents of SMIL metafile 1418 which is used to describe the data in the QuickTime Movie File 1402 (FIG. 14) and plaintext file 1413 (FIG. 14). In addition to metadata such as title, and layout information (including, for example, the size of the video and closed captioning regions used by the Apple QuickTime Player), the SMIL metafile 1118 includes a URL to identify the QuickTime Movie File 1402 and plaintext file 1413 to be played and rendered. The video region is sized as 320 pixels wide by 240 pixels tall. The closed captioning region (called the “text region” in the SMIL metafile 1118) is 320 pixels wide by 60 pixels tall and is positioned, in this illustrative example, below the video region.

Reference numerals 1604 and 1606, respectively, show the “video src” value which indicates the location of the QuickTime Movie File 1402 and “textstream src” value which indicates the location of the plaintext closed captioning file 1413. In this illustrative example, the location is a QuickTime media server disposed in multimedia server 105 (FIG. 1) which is arranged to stream content to the client device 125 (FIG. 1). In this illustrative example the RTSP server control protocol is used. As noted above, other usable server control protocols include MMS and HTTP.

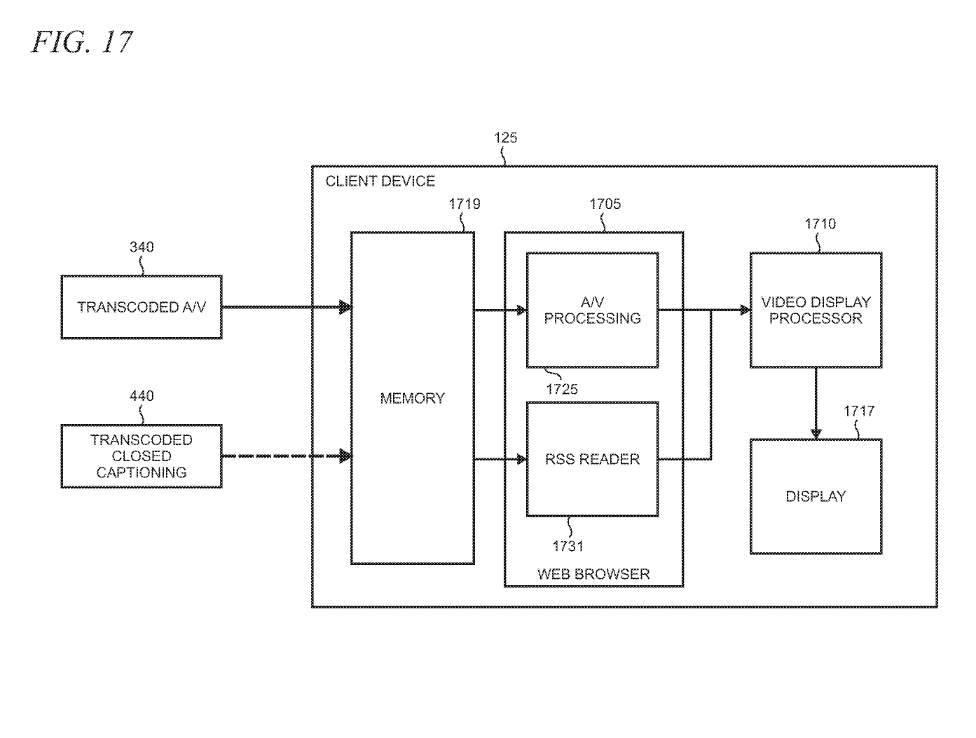

FIG. 17 is a block diagram of a second illustrative arrangement for a client device 125 (FIG. 1). Client device 125 hosts a web browser application 1705 that is functionally coupled, in typical consumer electronic devices, to a video display processor 1710 which renders video and visual data content on a display 1717. Display 1717 is arranged with similar features and functions as display 617 in FIG. 6.

A transcoded A/V signal 340 is received by the client device 125 which typically contains programming content such as a television show or movie. As noted above, the transcoded A/V signal is formatted to be usable by the media player hosted by the client device 125. For example, the transcoded A/V signal is coded in HTML with embedded video content that is either streamed or served from multimedia server 105 (FIG. 1).

The transcoded A/V signal 340 is buffered or stored in memory 1719. The transcoded closed captioning 440 that is associated with the television programming in transcoded A/V signal 340 is also buffered or stored in memory 1719. The transcoded A/V signal 340 and closed captioning 440 are read from memory 1719 by web browser 1705. Web browser 1705 supports several processes including A/V processing 1725 and RSS (Really Simple Syndication) reader 1731. A/V processing 1725 includes decoding and decrypting the transcoded A/V signal 340, as appropriate, and then outputting a corresponding video output signal to video display processor 1710 for display on display 1717. A/V processing 1725 is generally implemented using a media player plug-in to web browser 1705. Such plug-ins are supplied by the major media player providers including Microsoft, RealMedia, and Apple with similar features and functions as the standalone media players described above.

RSS is a file format based on XML and is commonly used as a web feed format. RSS readers are often implemented as standalone programs or incorporated into standard web browsers as a plug-in. Accordingly, in this illustrative example, transcoded closed captioning 440 is coded in XML to include the closed captions, timing, and style information. RSS reader 1731 includes functionality for parsing the transcoded closed captioning 440, synchronizing the closed captioning with the A/V signal 340 and then outputting the closed captions to the video display processor 1710 so that they are rendered on the display 1717.

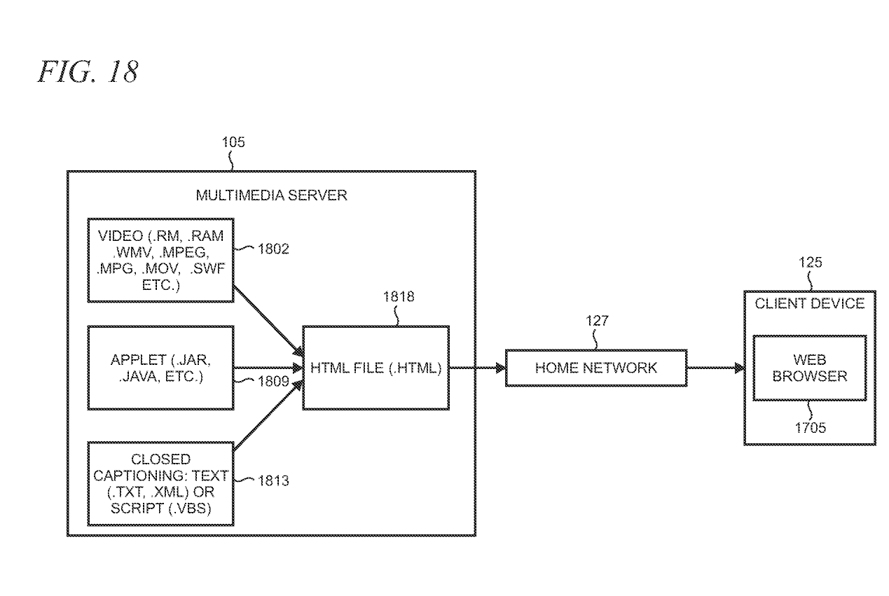

FIG. 18 shows a fourth illustrative set of files served by multimedia server 105 (FIG. 1). The files shown in FIG. 18 are transmitted over the home network 127 (FIG. 1) and used by the client device 125 (FIG. 1) as arranged in FIG. 17 to render video content and associated closed captioning. Client device 125 hosts web browser 1705 which, in this illustrative example, is arranged to include a media player plug-in.

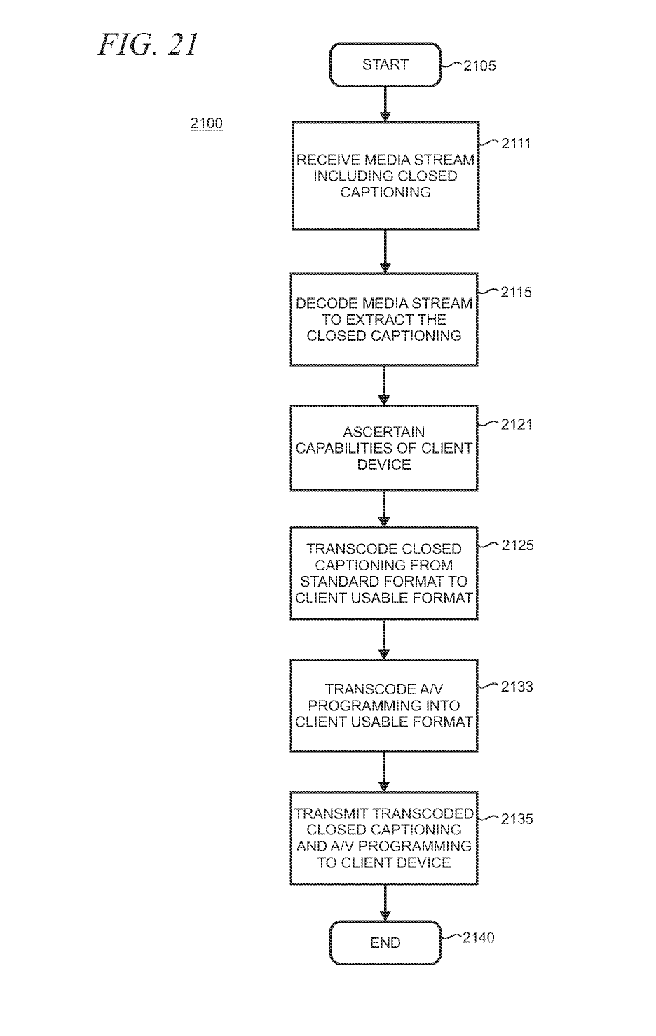

The transcoder 231 (FIG. 2) creates a video file 1802 during the A/V transcoding process. The video file is selected from one of a variety of media file formats including, for example, RealMedia Video, Windows Media Video, Apple QuickTime or Apple iTunes Video. Identification of the appropriate file type is typically made when the client device 125 makes a request to the multimedia server 105 to receive multimedia content, as described above. Alternatively, the multimedia server 105 is arranged to ascertain the capabilities of the client devices 125 through a discovery or query process. This alternative arrangement is described below in more detail in the text accompanying FIG. 21.

The closed captioning module 222 (FIG. 2) generates a closed captioning file 1813 that is arranged as a text file such as plaintext or xml (with .txt or .xml extensions, respectively). Closed captioning file 1813 is alternatively arranged as a script file, for example, a visual basic script (having a .vbs extension). Closed captioning file 1813 includes closed captions, timing and style information.

Both the transcoded video file 1802 and closed captioning file 1813 are embedded or otherwise linked, in this illustrative example, in an HTML file 1818 that is served to the client device 125. In alternative arrangements, the process of embedding the video and closed captioning files into the HTML file 1818 is performed by transcoder module 231 (FIG. 2), or the closed captioning module 222 (FIG. 2), or a combination of both. In other illustrative examples, the embedding is performed by other elements or components disposed in multimedia server 105 such as file creation software running on controller 215 (FIG. 2) or another processor.

A Java applet 1809 is also embedded in the HTML file 1818 that is served by multimedia server 105 to client device 125 over home network 127. Java applet 1809 is arranged as a single file (having a java extension) or as a plurality of files (having a jar extension). Java applet 1809 is executable code that is transferred in the HTML file 1818 and run by web browser 1705 using a Java Virtual Machine plug-in. The Java Virtual Machine provides the environment that runs programs (i.e., applets) written in the Java language. Java applet 1809 provides a programmatic structure for the web browser 1705 to render the closed captioning file 1813. In particular, java applet 1809 renders closed captioning synchronously with media content contained in the video file 1802 in a captioning region that is defined in the HTML file 1818 using captioning, style and timing data included in closed captioning file 1813. Java applet 1809 thus provides an alternative to SMIL when web browser 1705 does not support SMIL or has a media player plug-in that does not support SMIL.

By embedding the video and closed captioning in an HTML file, the user is allowed to access the content without requiring another application to be opened which may be advantageous in some applications of closed captioning distribution over a home network. The embedding is performed using, for example, conventional HTML tags including <applet>, <object>, or <embed> tags which contain elements and attributes required to identify and locate the video file 1802 and closed captioning file 1813. Accordingly, the HTML file 1818 functions, in this illustrative example, in a similar manner as the ASX metafile 718 (FIG. 7) and SMIL files 1118 (FIG. 11) and 1418 (FIG. 14).

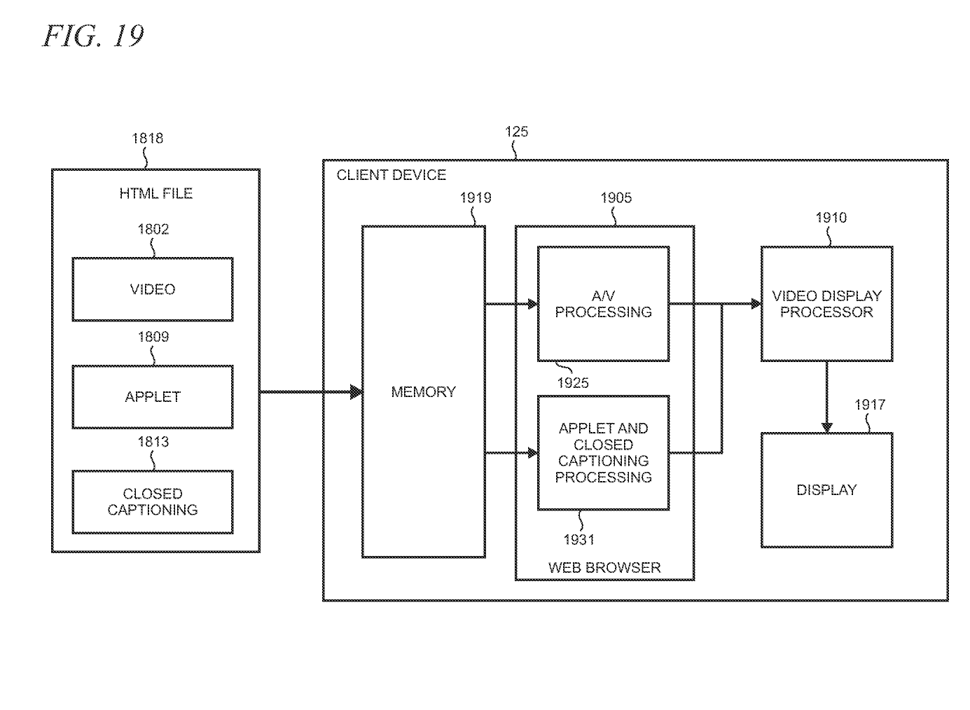

FIG. 19 is a block diagram of a third illustrative arrangement for a client device 125 (FIG. 1) that supports use of the files shown in FIG. 18 and described in the accompanying text. Client device 125 hosts a web browser application 1905 that is functionally coupled, in typical consumer electronic devices, to a video display processor 1910 which renders video and visual data content on a display 1917. Display 1917 is arranged with similar features and functions as display 617 in FIG. 6.

HTML file 1818 comprising the video file 1802, Java applet 1809 and closed captioning file 1813 is received by the client device 125. As described above, video file 1802 is generated during a transcoding process and typically includes programming content such as a television show or movie. Closed captioning file 1813 includes closed captioning that is associated with the programming content.

HTML file 1818 is buffered or stored in memory 1919. HTML 1818 file is read from memory 1919 by web browser 1905. Web browser 1905 supports several processes including A/V processing 1925 and applet and closed captioning processing 1931. A/V processing 1925 includes decoding and decrypting, as appropriate, the video file 1802 and outputting a corresponding video output signal to video display processor 1910 for display on display 1917. A/V processing 1725 is implemented using the media player plug-in for web browser 1905. Applet and closed captioning processing 1931 comprises executing the Java applet 1809, synchronizing the closed captioning with video file 1802 and then outputting the closed captions to the video display processor 1910 so that they are rendered on the display 1917.

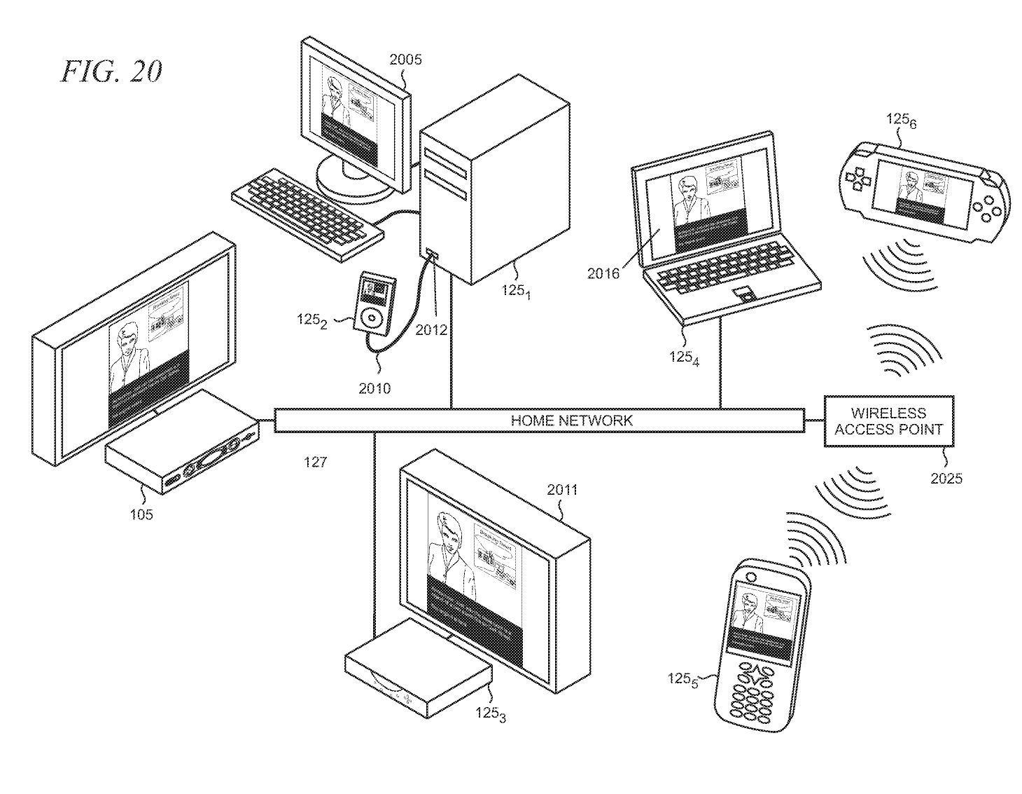

FIG. 20 is a pictorial view of an illustrative arrangement including multimedia server 105 (FIG. 1) that is coupled to a plurality of client devices 125₁ to 125_{N} (FIG. 1) over home network 127 (FIG. 1). Media server 105 is incorporated into an STB which is arranged as an advanced digital STB with optional DVR functionality. Such STBs are commonly referred to as “thick boxes” because of their comprehensive integrated feature set, powerful processors, large memories, and large hard disk drives. Personal computer, PC 125₁ is an illustrative example of a typical client device. PC 125₁ is optionally arranged as a media center-type PC typically having one or more DVD drives, a large capacity hard disk drive, and high resolution graphics adapter. PC 125₁ is coupled to home network 127 to enable access to streamed or stored media content from multimedia server 105. PC 125₁ hosts either a media player (such as media player 605 in FIG. 6) or a web browser (such as web browser 1705 in FIG. 17). As shown, PC 125₁ displays programming content and synchronous captioning (as illustratively depicted in FIG. 10) on a coupled display device 2005 which is arranged as a flat panel monitor. PC 125₁, in alternative arrangements, is utilized as a multimedia server having similar content sharing/serving functionalities and features as multimedia server 105 described herein.

PC 125₁ also hosts a user interface to enable a user to browse, select and then play media content and associated closed captioning that is served from or stored on multimedia server 105. Such user interface is configured, in this illustrative example, using an EPG-like interface that enables media content to be selected, accessed and controlled. That is, the user interacts with PC 125₁ to select and view media content and closed captioning as if the content and closed captioning were delivered directly to the PC 125₁ and in the proper format. The transcoding of the media content and closed captioning performed at the multimedia server 105 is thus transparent to the user. The user interface is alternatively arranged as a standalone application, or more typically built into the media player or HTML pages displayed by the web browser.

A portable media player 1252 is coupled via cable 2010 to a port 2012 disposed in PC 125₁. Port 2012 is arranged as a USB (Universal Serial Bus) or IEEE-1394 (sometimes referred to as a “FireWire”) port, for example, and enables portable media player 125₂ to download content from home network 127 using PC 125₁. PC 125₁ typically is arranged to run a media content interface application to manage media content on portable media player 125₂.

Portable media player 125₂ is arranged to play a variety of multimedia including music, pictures, and video. Many portable media players include a media player with native support for MPEG-4 formatted video (having .mp4, .m4v, or .mp4v files extensions). As shown, portable media player 125₂ displays programming content and synchronous captioning (as illustratively depicted in FIG. 10) on its built-in display device.

Thin client STB 125₃ is coupled to a television 2011 and to home network 127. As shown, STB 125₃ displays programming content and synchronous captioning (as illustratively depicted in FIG. 10) on monitor 2011. Thin client STB 125₂ is an example of a class of STBs that feature basic functionality, usually enough to handle common EPG and VOD/PPV functions. Such devices tend to have lower powered central processing units and less random access memory than thick STBs such as multimedia server 105 above. However, thin client STB 125₃ is configured with sufficient resources to host a media player (such as media player 605 in FIG. 6), a web browser (such as web browser 1705 in FIG. 17), user interface (as described above) or other software application to enable a user to browse, select, and play content served from or stored on multimedia server 105.

Laptop computer 1254 is also coupled to home network 127 and typically hosts either a standalone media player or web browser, or both applications (such as media player 605 in FIG. 6 and web browser 1705 in FIG. 17, respectively). As shown, Laptop computer 1254 displays programming content and synchronous captioning (as illustratively depicted in FIG. 10) on its built-in display 2016. Using a standalone user interface application or an interface that is integrated with the media player or web browser, a user is able to transparently browse, select and play content served from or stored on multimedia server 105.

A wireless access point 2025 is coupled to home network 127. Wireless access point 2025 is arranged, in this illustrative example, as a Wi-Fi access point that utilizes a wireless communications protocol in accordance with IEEE 802.11x. Wireless access point 2025 enables portable electronic devices such as mobile phones, PDAs, handheld games, music players and the like, to communicate over, and receive media content from sources such as multimedia server 105 on home network 127.

Mobile phone 125₅ is in operative communication with wireless access point 2025 to receive media content from multimedia server 105. Mobile phones commonly are configured to play a variety of multimedia types including music and video. Native video formats include MPEG-4 or the 3GP format defined by 3GPP, the 3^{rd} Generation Partnership Project (and having a .3gp or .3g2 file extension). As shown, mobile phone 125₅ displays programming content and synchronous captioning (as illustratively depicted in FIG. 10) on its built-in display.

A handheld game console 125₆ is in operative communications with wireless access point 2025 to receive media content from multimedia server 105. Handheld game console 125₆ is representative of the variety of lightweight, portable electronic machines for playing video games that are available. Such devices often include features beyond gaming such as an ability to play music and video and browse the Internet. Native video formats typically include MPEG-4, while some handheld game consoles also support DivX created by DivX Inc. (and having a .divx file extension). As shown, handheld game console 125₆ displays programming content and synchronous captioning (as illustratively depicted in FIG. 10) on its built-in display.

FIG. 21 is a flowchart of an illustrative method 2100 for distributing closed captioning from multimedia server 105 (FIG. 1) to client devices 125 (FIG. 1) over home network 127 (FIG. 1). The method starts at block 2105. At block 2111, multimedia server 105 receives a media stream and associated closed captioning that is encoded therein. At block 2115, the received media stream is decoded to extract the closed captioning.

At block 2121, multimedia server 105 ascertains the capabilities of client devices 125 on the network 127. In an illustrative example, capabilities are ascertained through a discovery process utilizing a command control communication protocol where each client device 125, upon connection to home network 127, publishes it capabilities to control points in the home network 127, including multimedia server 105. The description of capabilities may be formatted in any of a variety of conventional formats, for example, XML using the SOAP (Simple Object Access Protocol) or other similar protocols. Such client device capabilities include identification of the video format(s) that the client device 125 supports, a list of installed video codecs, and/or other optional data that describes the video rendering and display capabilities of the client device, including for example, display window size, resolution, and color depth. Such information enables multimedia server 105 to advantageously tailor the transcoded A/V and closed captioning to meet the specific characteristics of the media player in the client device. After multimedia server 105 receives a description of the capabilities of a client device 125, controller 215 (FIG. 2) instructs the transcoder 231 (FIG. 2) and closed captioning modules and 222 (FIG. 2) respectively, using suitable control messages to transcode an A/V channel and associated closed captioning into the format that conforms to the published description.

A first alternative to discovery is through multimedia server 105 affirmatively querying a client device 125 to ascertain its capabilities. For example, multimedia server 105 may be arranged to periodically poll client devices 125 that connect to home network 127. A second alternative is for the capabilities description of the client device 125 to be transmitted to the multimedia server 105 during the initiation of a multimedia viewing event as described above in the text accompanying FIG. 3. In this case, the capabilities description of the client device 125 is sent over home network 127 to multimedia server 105 along with the user's programming selection to be received by the client device 125.

At block 2125, the closed captioning extracted from the media stream is transcoded by closed captioning module 222 into a supported format for client device 125 responsively to the instructions of controller 222. At block 2133, the A/V programming selected by the user is transcoded by transcoder 231 into a supported video format for client device 125 responsively to the instructions of controller 222. At block 2135, the transcoded closed captioning and A/V programming is transmitted from multimedia server 105 over home network 127 to client device 125. The method ends at block 2140.

Each of the processes shown in the figures and described in the accompanying text may be implemented in a general, multi-purpose or single purpose processor. Such a processor will execute instructions, either at the assembly, compiled or machine-level, to perform that process. Those instructions can be written by one of ordinary skill in the art following the description herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

What is claimed is:

1. A method for distributing closed captioning from a server to a client over a network, the client hosting a media player, the method comprising:
receiving a media stream including closed captioning that is encoded therein in accordance with a first closed captioning format;
decoding the media stream to extract the closed captioning;
transcoding the closed captioning from the first closed captioning format to a format that is usable by the media player; and
transmitting the transcoded closed captioning to the client over the network.

2. The method of claim 1 in which the first closed captioning format conforms with a closed captioning format in accordance with one of the Consumer Electronic Association CEA-608-B, CEA-708-B, Advanced Television Systems Committee ATSC A/53 , Society of Cable Telecommunication Engineers SCTE 20 or SCTE 21.

3. The method of claim 1 further including transcoding the media stream and transmitting the transcoded media stream to the client.

4. The method of claim 3 further including transmitting the transcoded closed captioning to the client to thereby enable the media player to render the closed captioning synchronously with programming content in the media stream.

5. A computer-readable medium which, when executed by one or more processors disposed in a server, performs a method for providing closed captioning to a media player running on a client, the method comprising:
extracting closed captioning encoded in a media stream;
communicating with the client to determine closed captioning rendering capabilities of the media player; and
formatting the closed captioning responsively to the communicating so that the transcoded closed captioning is renderable by the media player.

6. The computer-readable medium of claim 5 further including transcoding the media stream from the received format into a native format that is recognizable by the media player.

7. The computer-readable medium of claim 5 in which closed captioning transcoding comprises decoding the closed captioning and generating, from the decoded closed captioning, a captioning file that is readable using a markup language.

8. The computer-readable medium of claim 5 in which the communicating is performed in accordance with a command control protocol implemented between the server and the client.

9. The computer-readable medium of claim 8 in which the command control protocol implements discovery of clients on the network that support the command control protocol.

10. A multimedia server, comprising:
a transcoder for transcoding a media stream into a transcoded media stream receivable by a client multimedia player, whereby the transcoded media stream is provided in a native stream format for the client multimedia player; and
a closed captioning codec for a) extracting closed captioning included in the media stream in a first closed captioning encoding format and b) encoding the decoded closed captioning into a captioning file that is renderable by the client multimedia player synchronously with the transcoded media stream.

11. The multimedia server of claim 10 further including a demodulator for tuning and demodulating a modulated signal from a feed.

12. The multimedia server of claim 10 in which the client multimedia player further includes a router for routing the transcoded media stream and captioning file to another client multimedia player.

13. The multimedia server of claim 12 in which the router encapsulates the transcoded media stream and captioning file as IP datagrams in an IP layer of an output stream whereby the IP datagrams include a destination address of the other client multimedia player.

14. The multimedia server of claim 13 in which the output stream is compliant with IEEE-1394.

15. The multimedia server of claim 12 in which the router provides the captioning file to the other client multimedia player asynchronously using a delivery protocol selected from one of AV/C or IP.

16. The multimedia server of claim 10 further including an applet server for providing an applet to the client multimedia player, the applet arranged to facilitate rendering of the captioning file by the client multimedia player.

17. The multimedia server of claim 16 in which the applet is a Java applet that processes the captioning file to thereby render captions on the client multimedia player in a synchronous manner with the transcoded media stream.

18. The multimedia server of claim 13 in which the output stream is supplied as an RSS feed.

19. The multimedia server of claim 18 in which the client multimedia player includes an RSS reader.

20. The multimedia server of claim 10 in which the multimedia server and client multimedia player are connectable over a network, the network being selected from one of coaxial cable network, MoCA (Multimedia over Coax Alliance) network, HomePlug network, HPNA (Home Phoneline Networking Alliance) network, powerline network, wired network, wireless network or telephone network.
